(19) United States
(12) Patent Application Publication
(10) Pub. No.: US 2003/0233407 A1
(43) Pub. Date: Dec. 18, 2003

(54) Control device

(76) Inventors: Vladimir Khavrov, Munchen (DE); Albrecht Mayer, Deisenhofen (DE); Harry Siebert, Puchheim (DE); Martin Terry, Bristol (GB)

Correspondence Address: LERNER AND GREENBERG, P.A., POST OFFICE BOX 2480, HOLLYWOOD, FL, 33022-2480, US

(21) Appl. No.: 10/397,143

(22) Filed: Mar. 26, 2003

(30) Foreign Application Priority Data
Mar. 26, 2002 (EP) 02 006 874.8

(51) Int. Cl. G06F 15/16

(52) U.S. Cl. 709/203

(57) ABSTRACT

A control device is provided for observing and/or changing internal states and processes of a controllable unit from outside the unit. The control device is a component of a network including a server and two or more clients. The clients are system components for initiating or carrying out the observation, change and/or evaluation of the internal states and processes of the programmable unit. Whenever the clients access the programmable unit in order to carry out the necessary tasks they are responsible for, they transmit to the server a request that specifies what action is to be initiated by the access. The server defines how the programmable unit must be accessed in order to carry out the actions specified by the requests, and carries out the corresponding access to the programmable unit.

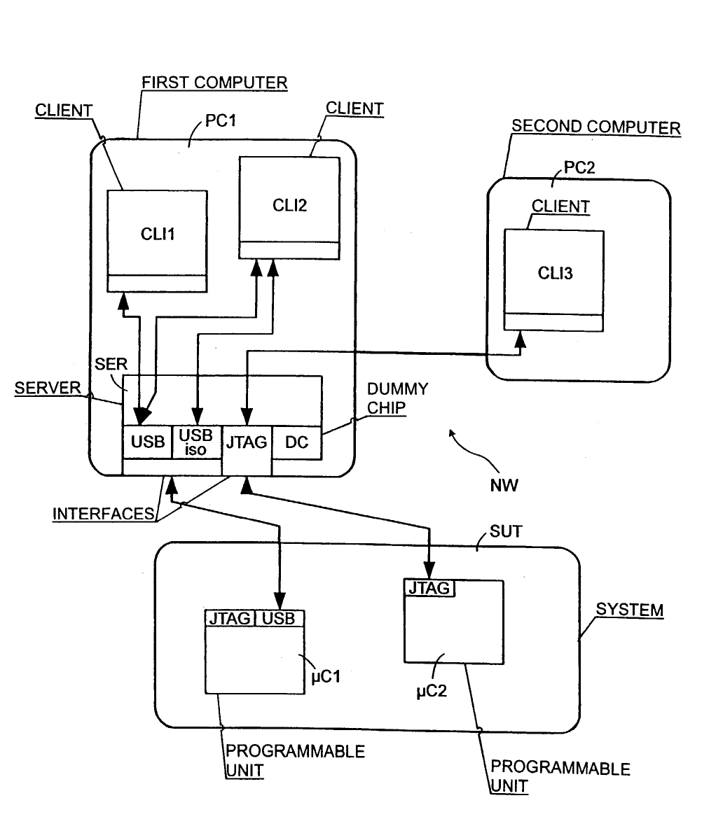

### BACKGROUND OF THE INVENTION

1. Field of the Invention

The present invention relates to a control device that can be used to observe and/or change the internal states and the processes of a programmable unit from outside the unit.

A control device such as this is a component of widely differing tools and appliances and can be, for example, a component of so-called emulation or debug-tools used for localizing and rectifying errors or faults that occur during the operation of a programmable unit. A control device such as this could alternatively be a component of a so-called calibration tool used to make changes to specific settings during operation of the programmable unit, for example, changes to parameters used by the program being run by the programmable unit. A control device such as this could alternatively be a component of a so-called fast-prototyping-tool for detecting, during operation of a programmable unit, the effects of changes to settings, for example, the effects of changes to parameters used by the program being run by the programmable unit during operation of the programmable unit. These settings can be changed as a function of the detected effects.

The programmable units are, for example, microprocessors, microcontrollers, signal processors and the like. For the sake of completeness, it should be noted, however, that these apparatus must incorporate precautionary measures to allow access to the internal states or processes, that is to say, like a so-called bond-out version of a programmable unit, for example, they must have additional input and/or output connections, or they must have a so-called on chip debug support module (OCDS module).

The actions that allow the control device to observe or change internal states and processes of the programmable unit include, by way of example:

reading and changing the contents of registers or of other internal memory or storage devices;

initiating the programmable unit to use a so-called overlay memory instead of the program memory from which the programmable unit obtains the commands that will be carried out;

initiating the programmable unit to interrupt the process of carrying out commands;

initiating the programmable unit to output so-called trace data; and

initiating the programmable unit to carry out the stated actions and other actions when specific states or events occur, etc.

These actions have been listed merely as examples and are not exclusive.

Furthermore, it is necessary or desirable for two or more tools of the abovementioned tools and/or other tools that contain a control device of the type mentioned initially to be used at the same time, that is to say to be connected to the programmable unit and to cooperate with it at the same time.

In general, this leads to problems since the tools that have been mentioned frequently originate from different manufacturers because of the completely different tasks that are carried out by them, and they do-not cooperate, or frequently do not cooperate directly. In particular, there is a considerable probability of the various tools interfering with one another.

### SUMMARY OF THE INVENTION

It is accordingly an object of the invention to provide a control device constructed as a component of a network, which overcomes the above-mentioned disadvantages of the prior art apparatus of this general type.

In particular, the present invention is based on the object of ensuring, in a simply manner, that accesses initiated from different sources to the programmable unit do not interfere with one another. These accesses enable the internal states and processes of the programmable unit to be observed and changed from outside the unit.

With the foregoing and other objects in view there is provided, in accordance with the invention, a network in combination with a programmable unit having internal states and processes. The network includes: a server; and at least two clients for carrying out or initiating an observation, a change, and/or an evaluation of the internal states and the processes of the programmable unit. Each of the clients is responsible for carrying out necessary tasks by accessing the server. Each of the clients is configured for accessing the server by transmitting a request to the server. The request specifies what action will be initiated by the accessing of the server. The server defines how the programmable unit must be accessed to carry out the action specified by the request and the server carries out a corresponding access to the programmable unit.

In accordance with an added feature of the invention, the request is transmitted as a request list including a multiplicity of requests.

In accordance with an additional feature of the invention, the server is configured to prohibit processing of any other requests while processing the multiplicity of requests contained in the request list.

In accordance with another feature of the invention, a respective one of the clients transmits further requests or request lists to the server before the server has processed requests or request lists that have already been supplied to the server by the respective one of the clients.

In accordance with a further feature of the invention, the server is configured such that when the clients transmit a plurality of requests to the server, the server defines a sequence for processing the plurality of requests, taking account of priorities allocated to ones of the clients from which the plurality of requests originated.

In accordance with a further added feature of the invention, the server is configured such that when the clients transmit a plurality of requests or request lists to the server, the server defines a sequence for processing the plurality of requests or request lists, taking account of priorities allocated to the clients from which the plurality of requests or request lists originated.

In accordance with a further additional feature of the invention, the server is configured such that when the clients transmit a plurality of requests or request lists to the server, the server defines a sequence for processing the plurality of requests or request lists, taking account of priorities that the clients issuing the plurality of requests or request lists have assigned to the plurality of requests or request lists.

In accordance with yet an added feature of the invention, the server is configured such that when one of the clients transmits a request or request list to the server, the server, before processing the requests or the request lists, checks whether the one of the clients is authorized to initiate actions specified by the request or the request list.

In accordance with yet an additional feature of the invention, the server includes at least a partial model of the programmable unit for checking whether the server is functioning correctly.

In accordance with yet another feature of the invention, the model additionally or alternatively serves for checking whether at least one of the clients is functioning correctly.

In accordance with yet a further feature of the invention, the server includes at least a partial model of the programmable unit for checking whether the server and the clients are cooperating correctly.

Whenever the clients access the programmable unit in order to carry out the necessary tasks that they are responsible for, they transmit, to the server, a request that specifies what action is to be initiated by the access. The server defines how the programmable unit must be accessed in order to carry out the actions specified by the requests, and carries out the corresponding access to the programmable unit.

Since only the server can access the programmable unit, it is reliably possible to prevent interfering accesses from different components to the programmable unit.

Other features which are considered as characteristic for the invention are set forth in the appended claims.

Although the invention is illustrated and described herein as embodied in a control device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The sole drawing figure shows the configuration of the arrangement described in the following text.

### DESCRIPTION OF THE PREFERRED EMBODIMENTS

Referring now to the sole drawing figure in detail, there is shown a system SUT that will be investigated and a network NW that is connected to the system SUT.

The system SUT that will be investigated in the example under consideration is an electrical printed circuit board, on which two programmable units μC1 and μC2 and various further components which are not shown in the figure, such as memories, drivers, interfaces, etc. are provided.

The programmable units μC1 and μC2 are, for example, microprocessors, microcontrollers, signal processors or the like, and are constructed to allow a device provided outside the programmable units to determine and change internal states and processors of the programmable units by appropriately accessing them.

The device provided outside the programmable unit is the network NW. This network, to be more precise, a server SER in it, is connected to the programmable units via interfaces provided in the programmable units μC1 and μC2, and can determine and change internal states and processes of the programmable units by accessing the programmable units for this purpose. The interfaces via which the programmable units are connected to the server in the example under consideration are a USB interface (programmable unit μC1) and a JTAG interface (programmable unit μC2). However, it should be mentioned that the programmable units may be connected to the server SER independently of one another via any desired interface. In particular, the connection may also be made via interfaces other than via a USB interface or a JTAG interface and, furthermore, there is also no need for the programmable units to be connected to the server SER via different interfaces. If one of the programmable units is a bond-out version or the like, the connection to the server is made via two or more separate lines, rather than via a standardized interface.

In addition to the server SER, which has already been mentioned above, the network NW contains three clients CLI1, CLI2, and CLI3. The server SER and the clients CLI1 and CLI2 are accommodated in a first computer PC1, and the client CLI3 is accommodated in a second computer PC2. For the sake of completeness, it should be mentioned that any desired greater or lesser number of clients can be provided, and that the server and the clients may be distributed in any desired manner between any desired number of computers.

The clients, which are a component of the computer containing the server, that is to say in the example under consideration the clients CLI1 and CLI2, are connected to the server SER via software interfaces. The clients which are not a component of the computer which contains the server, that is to say in the example under consideration the client CLI3, are connected to the server via a network connection, for example via an Ethernet LAN using the TCP/IP protocol.

The clients are in the form of software—possibly with the exception of the interfaces to the server. However, this is an application program which, depending on the task to be carried out by the respective client:

(1) controls and/or checks the interfaces to the user of the arrangement (display apparatus, input apparatuses, etc.);

(2) initiates actions by means of which it can receive necessary information about the internal states and processes within the programmable unit;

(3) evaluates the received information; and/or

(4) initiates actions by means of which the internal states and processes within the programmable unit are changed as required.

In the example under consideration, the clients CLI1 to CLI3 have to carry out different tasks. To be more precise, the client CLI1 is provided for debugging a first core of the programmable unit μC1, the client CLI2 is provided as a calibration tool for the second programmable unit μC2, and the client CLI3 is provided for debugging the second core of the programmable unit μC1. It should be obvious that the existing clients can carry out any desired tasks independently on one another.

The task that a respective client has to carry out governs which of the actions (1) to (4) mentioned above is carried out. That is to say, the program which represents the client determines the function of the client, that is to say whether this client (in conjunction with the server SER) is a debug tool, a calibration tool, a fast-prototyping tool or some other tool.

The server SER is partially in the form of hardware, and partially in the form of software. The various interfaces to the system SUT that will be investigated and the programmable units μC1 and μC2 provided in this system are in the form of hardware; the rest is in the form of software.

Finally, the server SER is nothing more than an intelligent interface between the clients CLI1 to CLI3 and the programmable units μC1 and μC2.

The server SER receives resultant requests from the clients CLI1 to CLI3, to be more precise from the client actions (2) and (4) mentioned above, and then causes the programmable devices μC1 and μC2 to carry out the operations which are necessary to carry out the requests from the clients.

The requests that are emitted by the clients exclusively specify the actions that will be carried out in the programmable units, that is to say, for example, that when the instruction point of the programmable unit μC1 has a specific value, the content of a specific register of the programmable unit μC1 will be read and emitted. In particular, the requests do not contain any information whatsoever as to how to access the programmable units μC1 and μC2, in order to carry out the action specified in the requests. The definition of the way in which the programmable units μC1 and μC2 must be accessed in order to carry out the actions specified in the requests is provided by the server SER, to be more precise by a chip adaptation layer of the server that is matched to the programmable units.

The chip adaptation layer contains associations between the actions which can be and may be initiated by the clients, and the accesses to the programmable units which must be carried out in order to initiate the relevant actions.

The association also takes account of the so-called workarounds which are required when a programmable unit is intended to carry out a specific action, which it would actually have to be able to carry out but—for whatever reason—cannot carry out. The workarounds contain definitions of which action or actions can be replaced by an action which can be carried out.

After determining the respective accesses to be carried out to a programmable unit, the server signals to the client, from which the original request originated, that the access has been carried out. Furthermore, if necessary, the server also transmits to the client data that the client wished to receive by making the relevant request.

The clients CLI1 to CLI3 are able to transmit request lists containing two or more requests to the server.

This has been found to be advantageous for two or more reasons.

First, the requests from the clients can be transmitted to the server in a shorter time that would be possible if each request were transmitted individually. Second, it is possible in this way to signal to the server that it must carry out two or more requests, to be more precise the requests contained in a request list, without any interruption, that is to say without in the mean time carrying out any other requests.

It is preferable for a client to be able to transmit further requests or request lists to the server, if required, even at a time at which the server has not yet processed the requests or request lists already supplied to it by this client.

The server preferably carries out the requests contained in a request list without any interruption, that is to say it does not carry out any other requests from that client or requests to other clients in the meantime.

Furthermore, the server is able to decide the sequence in which the requests or request list that arrive at it are to be processed. The sequence in which the server processes the requests in the simplest case corresponds to the sequence in which the relevant requests arrive at the server. However, the server is preferably also able to use other criteria to define the sequence in which it will process the requests that arrive at it. By way of example, it has been found to be advantageous for the server to be able to define the sequence as a function of priorities which are assigned to the existing clients, and/or which the clients have assigned to the requests emitted by them or to the request lists emitted by them. This means that it is possible to carry out important requests with a waiting time that is as short as possible.

In the example under consideration, the server SER contains a component which is referred to as a dummy chip DC in addition to the components which have already been mentioned above. This component is a component of the chip adaptation layer, which has already been mentioned above, and contains an at least partial model of at least one of the programmable units which the server can access in accordance with the arrangements supplied to it. The clients can state that the requests transmitted to the server relate to the dummy chip.

It is thus possible to check the direct operation of the server and/or of the clients and/or the correct calibration between the server and the clients. In consequence, by way of example, it is possible, but by no means exclusively possible, to check:

whether the client and the server are correctly connected to one another and; or

whether the server converts the requests supplied to it to the correct accesses.

The described arrangement has been found to be advantageous for many reasons. In particular, it is reliably possible to prevent accesses that have been initiated from different system components to the programmable unit from interfering with one another.

We claim:

1. In combination with a programmable unit having internal states and processes, a network comprising:
a server; and
at least two clients for carrying out or initiating at least one function selected from a group consisting of an observation, a change, and an evaluation of the internal states and the processes of the programmable unit;
each of said clients responsible for carrying out necessary tasks by accessing said server;
each of said clients configured for performing the accessing of said server by transmitting a request to said server, said request specifying what action will be initiated by the accessing of said server; and
said server defining how the programmable unit must be accessed to carry out the action specified by said request and said server carrying out a corresponding access to the programmable unit.

2. The network according to claim 1, wherein said request is transmitted as a request list including a multiplicity of requests.

3. The network according to claim 2, wherein said server is configured to prohibit processing of any other requests while processing said multiplicity of requests contained in said request list.

4. The network according to claim 1, wherein a respective one of said clients transmits further requests or request lists to said server before said server has processed requests or request lists that have already been supplied to said server by said respective one of said clients.

5. The network according to claim 1, wherein said server is configured such that when said clients transmit a plurality of requests to said server, said server defines a sequence for processing said plurality of requests, taking account of priorities allocated to ones of said clients from which said plurality of requests originated.

6. The network according to claim 1, wherein said server is configured such that when said clients transmit a plurality of requests or request lists to said server, said server defines a sequence for processing said plurality of requests or request lists, taking account of priorities allocated to said clients from which said plurality of requests or request lists originated.

7. The network according to claim 1, wherein said server is configured such that when said clients transmit a plurality of requests or request lists to said server, said server defines a sequence for processing said plurality of requests or request lists, taking account of priorities that said clients issuing said plurality of requests or request lists have assigned to said plurality of requests or request lists.

8. The network according to claim 1, wherein said server is configured such that when one of said clients transmits a request or request list to said server, said server, before processing said requests or said request lists, checks whether said one of said clients is authorized to initiate actions specified by said request or said request list.

9. The network according to claim 1, wherein said server includes at least a partial model of the programmable unit for checking whether said server is functioning correctly.

10. The network according to claim 9, wherein said model also serves for checking whether at least one of said clients is functioning correctly.

11. The network according to claim 1, wherein said server includes at least a partial model of the programmable unit for checking whether at least one of said clients is functioning correctly.

12. The network according to claim 1, wherein said server includes at least a partial model of the programmable unit for checking whether said server and said clients are cooperating correctly.
